(19) United States
(12) Patent Application Publication
(10) Pub. No.: US 2015/0286958 A1
(43) Pub. Date: Oct. 8, 2015

(54) Interactive learning management method

(71) Applicants: Chien Cheng Liu, Kaohsiung (TW); Kuan Chen Wang, Kaohsiung (TW)

(72) Inventors: Chien Cheng Liu, Kaohsiung (TW); Kuan Chen Wang, Kaohsiung (TW)

(21) Appl. No.: 14/748,200

(22) Filed: Jun. 23, 2015

(51) Int. Cl. G06Q 10/00; G09B 5/06; G06Q 50/20

(52) U.S. Cl. CPC G06Q 10/00; G06Q 50/205; G09B 5/065

(57) ABSTRACT

An interactive learning management method includes abilities to automatically establish group settings on the learning communication mobile application based on the user identities, and to conduct real-time information transmission of class announcements, test paper scores, tutor comments and replies etc, to carry out learning interactions with the teacher by recording video clips of questions and answers, and to download mobile applications for learning via the Internet. The method provides a realization for transmission of learning information and archive photos by the users on the mobile device end through the learning communication mobile application and for downloading remote learning-oriented mobile applications for use, so that users can conduct real-time information notifications or learning through the mobile applications oriented to specific courses on the mobile device without limit of time and place. As a result, learning efficiency can be greatly increased.

### BACKGROUND OF THE INVENTION

1. Field of the Invention

The invention relates to interactive learning management methods and more particularly to an interactive learning management method having improved characteristics.

2. Description of Related Art

In common teaching courses, in order to check the teaching and learning effects, most instructors would arrange quizzes or learning tests or exams in the class to have a real-time understanding of the actual learning situations of all learners in the class. Then, regarding those units, test item types or wrong answer questions that most learners are unfamiliar with, subsequent teaching and tutoring will be carried out in the class through test paper analyses or intensified courses.

However, such a teaching and tutoring test method is usually subject to the limitation of teaching progress and teaching hours. Hence, most instructors would choose to review the error-prone questions or key questions only. Naturally, the result is uniform teaching and tutoring, instead of personalized teaching and tutoring based on the individual learning situations of different learners. This causes a poor learning effect, and often a waste of time in repetitive practices and reviews of those course units that the learners are already familiar with.

Thus, the need for improvement exists.

### SUMMARY OF THE INVENTION

It is therefore one object of the invention to provide an interactive learning management method configured to implement in an interactive learning management system including a learning management mobile server, a learning management website server, a learning management system server, a system backup server, a plurality of mobile devices, and a mobile application platform server wherein the system backup server is configured with a data storage device; the learning management mobile server, the learning management website server, the learning management system server, and the system backup server are inter-connected via networking; wherein the learning management mobile server and the learning management website server can both access the Internet through networking; and the mobile application platform server can access the Internet through networking; the mobile devices can access the Internet through telecommunication network or wireless network, so as to access the learning management mobile server, the learning management website server or the mobile application platform server; the mobile application platform server is configured with a mobile applications database; and the mobile applications database includes: learning communication mobile application, tutoring course mobile application, teaching aid mobile application, extended test mobile application and game learning mobile application; wherein the learning communication mobile application is used between the student or parents for real-time and dynamic information notification, text newsletters transmission, archive photos provision, webpage links and learning information announcement; the tutoring course mobile application is for display of the documents and materials of the main content of the teaching course, dynamic multimedia audio and video interaction and URL links; the teaching aid mobile application is for display of the documents and materials of reference information of the teaching courses; the extended test mobile application is for provision of the test papers of the teaching courses progress tests, dynamic multimedia audio and video interaction and URL links; the game learning mobile application is for provision of interactive and dynamic multimedia audio and video games related to the content of the teaching courses; the learning management mobile server is configured with a mobile learning database, a real-time information mobile database, a video mobile database and a new knowledge mobile database; wherein the mobile learning database is for storage of the account numbers, personal information and student data of the students or parents who use the learning communication mobile application on the mobile devices; the real-time information mobile database is for storage of related data of text newsletters or archive photos transmitted between the students or parents and the learning management personnel via the learning communication mobile application; the video mobile database is for storage of video files for contacting or communication between the students or parents and the learning management personnel via video clips; the new knowledge mobile database is for storage of related data of abstracts and full-text links about recent culture, education, learning, enrollment, research and new knowledge; the learning management system server is configured with a teaching courses database, a teaching aid database, a test paper database and a new knowledge database; wherein the teaching courses database is for storage of all learning content and related archive data used for the teaching courses; the teaching aid database is for storage of all reference information and related archive data used for the teaching courses; the test paper database is for storage of all test paper content and related archive data; the new knowledge database is for storage of full texts and related data about domestic and overseas culture, education, learning, enrollment, research and new knowledge; the mobile devices is installed with a learning communication mobile application; the mobile devices can be networked through the installed learning communication mobile application, and access the learning management mobile server via the Internet; and the mobile devices can be networked through the built-in web browser, and access the learning management website server via the Internet; wherein the mobile devices can be smart phones or tablets; the system backup server can, via networking, regularly or irregularly back up the data files of the mobile learning database, the real-time information mobile database, the video mobile database and the new knowledge mobile database of the learning management mobile server in the data storage device of the system backup server; or, via networking, back up the data files of the teaching courses database, the teaching aid database, the test paper database and the new knowledge database of the learning management system server in the data storage device of the system backup server, the interactive learning management method comprising the steps of installing the mobile devices with the learning communication mobile application which can access the learning management mobile server via the mobile devices, the learning communication mobile application can be automatically connected to the mobile learning database of the learning management mobile server, and by reading and comparing the account numbers, personal information and student data of the students or parents stored in the mobile learning database, automatically establish group settings or join class groups, parents groups, or learning groups in the learning communication mobile application based on the user identities on the mobile devices, so that the users or the learning management personnel can send or receive messages, data or files directly in the specific groups; allowing a learning management personnel to access the learning management mobile server via the learning management system server, and based on the student account numbers stored in the mobile learning database of the learning management mobile server, directly send real-time information of text newsletters or archive photos of class announcements, tutor instructions, test paper scores, learning guides and advices to the mobile devices; and the learning management mobile server will automatically back up the sent real-time information of text newsletters or archive photos in the corresponding real-time information mobile database of the learning management mobile server for storage or reading; and the students can, by executing the learning communication mobile application installed on the corresponding the mobile devices, review the real-time information of text newsletters or archive photos sent by the learning management personnel; allowing the learning management personnel to access the learning management mobile server via the learning management system server, and based on the parent account numbers stored in the mobile learning database of the learning management mobile server, directly send real-time information of text newsletters or archive photos about student check-in time, student check-out time, parent communications, test paper scores, tutor comments and replies to the corresponding mobile devices; and the learning management mobile server will automatically back up the sent real-time information of text newsletters or archive photos in the corresponding real-time information mobile database of the learning management mobile server for storage or reading; and the parents can, by executing the learning communication mobile application installed on the mobile devices, review the real-time information of text newsletters or archive photos sent by the learning management personnel; allowing students or parents to access the learning management mobile server via the corresponding mobile devices, and reply or send real-time information of text newsletters or archive photos via the learning communication mobile application installed on the mobile devices; and the learning management mobile server will automatically back up the received real-time information of text newsletters or archive photos in the corresponding real-time information mobile database of the learning management mobile server for storage or reading; and the learning management personnel can access the learning management mobile server via the learning management system server, and review the real-time information of text newsletters or archive photos sent by the students or parents in the real-time information mobile database of the learning management mobile server; allowing the learning management personnel to access the learning management mobile server via the learning management system server, and based on the student account number or parent account number stored in the mobile learning database of the learning management mobile server, directly send related data of abstracts and full-text links about recent culture, education, learning, enrollment, research and new knowledge stored in the new knowledge mobile database of the learning management mobile server to the corresponding mobile devices; allowing the students or parents to, by executing the learning communication mobile application installed on the mobile devices, review the related data of abstracts and full-text links about recent culture, education, learning, enrollment, research and new knowledge sent by the learning management personnel; or, by clicking the full-text links, access the learning management website server through the built-in web browser of the mobile devices and further access the new knowledge database of the internal learning management system server, so as to directly read the full texts and related data about domestic and overseas culture, education, learning, enrollment, research and new knowledge stored in the new knowledge database; allowing the students to make video clips of questions for any unclear or doubtful parts in the classroom teaching content, teaching aid materials or test papers, and describe the questions that are not clear or can not be understood through the video clips; Students can access the learning management mobile server via their respective mobile devices, and send question video clips via the learning communication mobile application installed on the mobile devices, The learning management mobile server will automatically back up the received questions video clips in the corresponding video mobile database of the learning management mobile server for storage or reading; allowing the learning management personnel to access the learning management mobile server via the learning management system server, and review the question video clips sent by the students in the video mobile database of the learning management mobile server, and notify the teacher to make reply video clips according to the question video clips of the students, to explain and clarify the related questions of the students; when the learning management personnel has obtained the reply video clips provided by the teacher, allowing the learning management personnel to access the learning management mobile server via the learning management system server, and back up the reply video clips in the video mobile database of the learning management mobile server for storage and reading; and meanwhile, based on the student account numbers stored in the mobile learning database of the learning management mobile server, the learning management personnel can directly send real-time information of text newsletters of reply notifications and reply video clip file links to the corresponding mobile devices; allowing the students to, by executing the learning communication mobile application installed on their respective mobile devices, review the real-time information of text newsletters of the reply notifications sent by the learning management personnel and the file links to the stored reply video clips, and know that the teacher has replied to their question video clips; and by clicking the file links to the stored reply video clips, access the learning management mobile server via their respective mobile devices, to play the reply video clips stored in the video mobile database of the learning management mobile server on the mobile devices; allowing the students to access the mobile application platform server via their respective mobile devices, and review the tutoring course mobile application, the teaching aid mobile application, the extended test mobile application and the game learning mobile application in the mobile applications database of the mobile application platform server based on their respective learning needs; and download and installed the mobile applications needed on their respective mobile devices, and review the key points of the teaching courses by executing the tutoring course mobile application on the mobile devices, or carry out aided learning with reference information of the teaching courses by executing the teaching aid mobile application, or carry out self-tests with the progress tests of the teaching courses by executing the extended test mobile application, or carry out fun learning of related content of the teaching courses by executing the game learning mobile application; and by clicking the URL links to the tutoring course mobile application, allowing the students to access the learning management website server through the built-in web browser on their respective mobile devices, and further access the internal teaching courses database of the learning management system server, so as to directly read the part of course learning content and related archive data stored in the teaching courses database and open for access according to their respective user permissions; or, by clicking the URL links to the teaching aid mobile application, students can access the learning management website server through the built-in web browser on their respective mobile devices, and further access the internal teaching aid database of the learning management system server, so as to directly read the part of reference information content and related archive data stored in the teaching aid database and open for access according to their respective user permissions; or, by clicking the URL links to the extended test mobile application, students can access the learning management website server through the built-in web browser on their respective mobile devices, and further access the internal test paper database of the learning management system server, so as to directly read the part of test paper content and related archive data stored in the test paper database and open for access according to their respective user permissions.

The above and other objects, features and advantages of the invention will become apparent from the following detailed description taken with the accompanying drawings.

### BRIEF DESCRIPTION OF THE DRAWINGS

FIG. 1 is a schematic block diagram of an interactive learning management system according to the invention, an interactive learning management method being tied to the system.

### DETAILED DESCRIPTION OF THE INVENTION

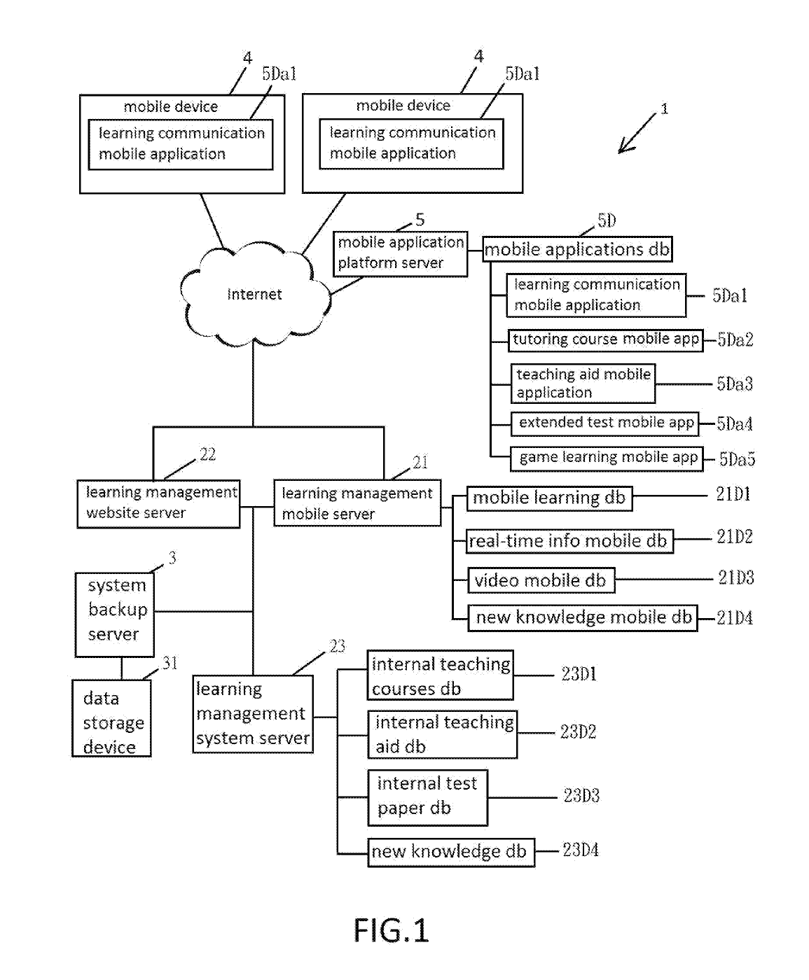

Referring to FIG. 1, an interactive learning management method in accordance with the invention is discussed in detail below.

The interactive learning management method is tied to an interactive learning management system 1. The interactive learning management system 1 comprises a learning management mobile server 21, a learning management website server 22, a learning management system server 23, a system backup server 3, a plurality of mobile devices 4 and a mobile application platform server 5; wherein the system backup server 3 is configured with a data storage device 31.

The learning management mobile server 21, the learning management website server 22, the learning management system server 23, and the system backup server 3 are inter-connected via networking. Wherein, the learning management mobile server 21 and the learning management website server 22 can both access the Internet through networking; and the mobile application platform server 5 can access the Internet through networking; the mobile devices 4 can access the Internet through telecommunication network or wireless network, so as to access the learning management mobile server 21, the learning management website server 22 or the mobile application platform server 5.

The mobile application platform server 5 is configured with a mobile applications database 5D; and the mobile applications database 5D includes: learning communication mobile application 5Da1, tutoring course mobile application 5Da2, teaching aid mobile application 5Da3, extended test mobile application 5Da4 and game learning mobile application 5Da5. Wherein the learning communication mobile application 5Da1 is used between the student or parents for real-time and dynamic information notification, text newsletters transmission, archive photos provision, webpage links and learning information announcement; the tutoring course mobile application 5Da2 is for display of the documents and materials of the main content of the teaching course, dynamic multimedia audio and video interaction and URL (uniform resource locator) links; the teaching aid mobile application 5Da3 is for display of the documents and materials of reference information of the teaching courses; the extended test mobile application 5Da4 is for provision of the test papers of the teaching courses progress tests, dynamic multimedia audio and video interaction and URL links; the game learning mobile application 5Da5 is for provision of interactive and dynamic multimedia audio and video games related to the content of the teaching courses.

The learning management mobile server 21 is configured with a mobile learning database 21D1, a real-time information mobile database 21D2, a video mobile database 21D3 and a new knowledge mobile database 21D4. Wherein the mobile learning database 21D1 is for storage of the account numbers, personal information and student data of the students or parents who use the learning communication mobile application 5Da1 on the mobile devices 4; the real-time information mobile database 21D2 is for storage of related data of text newsletters or archive photos transmitted between the students or parents and the learning management personnel via the learning communication mobile application 5Da1; the video mobile database 21D3 is for storage of video files for contacting or communication between the students or parents and the learning management personnel via video clips; the new knowledge mobile database 21D4 is for storage of related data of abstracts and full-text links about recent culture, education, learning, enrollment, research and new knowledge.

The learning management system server 23 is configured with a teaching courses database 23D1, a teaching aid database 23D2, a test paper database 23D3 and a new knowledge database 23D4. Wherein the teaching courses database 23D1 is for storage of all learning content and related archive data used for the teaching courses; the teaching aid database 23D2 is for storage of all reference information and related archive data used for the teaching courses; the test paper database 23D3 is for storage of all test paper content and related archive data; the new knowledge database 23D4 is for storage of full texts and related data about domestic and overseas culture, education, learning, enrollment, research and new knowledge.

The mobile devices 4 is installed with a learning communication mobile application 5Da1; the mobile devices 4 can be networked through the installed learning communication mobile application 5Da1, and access the learning management mobile server 21 via the Internet; and the mobile devices 4 can be networked through the built-in web browser, and access the learning management website server 22 via the Internet; wherein the mobile devices 4 can be smart phones or tablets.

The system backup server 3 can, via networking, regularly or irregularly back up the data files of the mobile learning database 21D1, the real-time information mobile database 21D2, the video mobile database 21D3 and the new knowledge mobile database 21D4 of the learning management mobile server 21 in the data storage device 31 of the system backup server 3; or, via networking, back up the data files of the teaching courses database 23D1, the teaching aid database 23D2, the test paper database 23D3 and the new knowledge database 23D4 of the learning management system server 23 in the data storage device 31 of the system backup server 3.

The interactive learning management method comprises the following: the mobile devices 4 installed with the learning communication mobile application 5Da1 can access the learning management mobile server 21 via the mobile devices 4, the learning communication mobile application 5Da1 can be automatically connected to the mobile learning database 21D1 of the learning management mobile server 21, and by reading and comparing the account numbers, personal information and student data of the students or parents stored in the mobile learning database 21D1, automatically establish group settings or join class groups, parents groups, or learning groups in the learning communication mobile application 5Da1 based on the user identities on the mobile devices 4, so that the users or the learning management personnel can send or receive messages, data or files directly in the specific groups.

The learning management personnel can access the learning management mobile server 21 via the learning management system server 23, and based on the student account numbers stored in the mobile learning database 21D1 of the learning management mobile server 21, directly send real-time information of text newsletters or archive photos of class announcements, tutor instructions, test paper scores, learning guides and advices to the mobile devices 4; and the learning management mobile server 21 will automatically back up the sent real-time information of text newsletters or archive photos in the corresponding real-time information mobile database 21D2 of the learning management mobile server 21 for storage or reading; and the students can, by executing the learning communication mobile application 5Da1 installed on the corresponding the mobile devices 4, review the real-time information of text newsletters or archive photos sent by the learning management personnel.

The learning management personnel can access the learning management mobile server 21 via the learning management system server 23, and based on the parent account numbers stored in the mobile learning database 21D1 of the learning management mobile server 21, directly send real-time information of text newsletters or archive photos about student check-in time, student check-out time, parent communications, test paper scores, tutor comments and replies to the corresponding mobile devices 4; and the learning management mobile server 21 will automatically back up the sent real-time information of text newsletters or archive photos in the corresponding real-time information mobile database 21D2 of the learning management mobile server 21 for storage or reading; and the parents can, by executing the learning communication mobile application 5Da1 installed on the mobile devices 4, review the real-time information of text newsletters or archive photos sent by the learning management personnel.

The students or parents can also access the learning management mobile server 21 via the corresponding mobile devices 4, and reply or send real-time information of text newsletters or archive photos via the learning communication mobile application 5Da1 installed on the mobile devices 4; and the learning management mobile server 21 will automatically back up the received real-time information of text newsletters or archive photos in the corresponding real-time information mobile database 21D2 of the learning management mobile server 21 for storage or reading; and the learning management personnel can access the learning management mobile server 21 via the learning management system server 23, and review the real-time information of text newsletters or archive photos sent by the students or parents in the real-time information mobile database 21D2 of the learning management mobile server 21.

The learning management personnel can access the learning management mobile server 21 via the learning management system server 23, and based on the student account number or parent account number stored in the mobile learning database 21D1 of the learning management mobile server 21, directly send related data of abstracts and full-text links about recent culture, education, learning, enrollment, research and new knowledge stored in the new knowledge mobile database 21D4 of the learning management mobile server 21 to the corresponding mobile devices 4.

The students or parents can, by executing the learning communication mobile application 5Da1 installed on the mobile devices 4, review the related data of abstracts and full-text links about recent culture, education, learning, enrollment, research and new knowledge sent by the learning management personnel; or, by clicking the full-text links, access the learning management website server 22 through the built-in web browser of the mobile devices 4 and further access the new knowledge database 23D4 of the internal learning management system server 23, so as to directly read the full texts and related data about domestic and overseas culture, education, learning, enrollment, research and new knowledge stored in the new knowledge database 23D4.

Students can make video clips of questions for any unclear or doubtful parts in the classroom teaching content, teaching aid materials or test papers, and describe the questions that are not clear or can not be understood through the video clips. Students can access the learning management mobile server 21 via their respective mobile devices 4, and send question video clips via the learning communication mobile application 5Da1 installed on the mobile devices 4. The learning management mobile server 21 will automatically back up the received questions video clips in the corresponding video mobile database 21D3 of the learning management mobile server 21 for storage or reading.

The learning management personnel can access the learning management mobile server 21 via the learning management system server 23, and review the question video clips sent by the students in the video mobile database 21D3 of the learning management mobile server 21, and notify the teacher to make reply video clips according to the question video clips of the students, to explain and clarify the related questions of the students.

When the learning management personnel has obtained the reply video clips provided by the teacher, he/she can access the learning management mobile server 21 via the learning management system server 23, and back up the reply video clips in the video mobile database 21D3 of the learning management mobile server 21 for storage and reading; and meanwhile, based on the student account numbers stored in the mobile learning database 21D1 of the learning management mobile server 21, he/she can directly send real-time information of text newsletters of reply notifications and reply video clip file links to the corresponding mobile devices 4.

The students can, by executing the learning communication mobile application 5Da1 installed on their respective mobile devices 4, review the real-time information of text newsletters of the reply notifications sent by the learning management personnel and the file links to the stored reply video clips, and know that the teacher has replied to their question video clips; and by clicking the file links to the stored reply video clips, access the learning management mobile server 21 via their respective mobile devices 4, to play the reply video clips stored in the video mobile database 21D3 of the learning management mobile server 21 on the mobile devices 4.

Students can access the mobile application platform server 5 via their respective mobile devices 4, and review the tutoring course mobile application 5Da2, the teaching aid mobile application 5Da3, the extended test mobile application 5Da4 and the game learning mobile application 5Da5 in the mobile applications database 5D of the mobile application platform server 5 based on their respective learning needs; and download and installed the mobile applications needed on their respective mobile devices 4, and review the key points of the teaching courses by executing the tutoring course mobile application 5Da2 on the mobile devices 4, or carry out aided learning with reference information of the teaching courses by executing the teaching aid mobile application 5Da3, or carry out self-tests with the progress tests of the teaching courses by executing the extended test mobile application 5Da4, or carry out fun learning of related content of the teaching courses by executing the game learning mobile application 5Da5.

By clicking the URL links to the tutoring course mobile application 5Da2, students can access the learning management website server 22 through the built-in web browser on their respective mobile devices 4, and further access the internal teaching courses database 23D1 of the learning management system server 23, so as to directly read the part of course learning content and related archive data stored in the teaching courses database 23D1 and open for access according to their respective user permissions. Or, by clicking the URL links to the teaching aid mobile application 5Da3, students can access the learning management website server 22 through the built-in web browser on their respective mobile devices 4, and further access the internal teaching aid database 23D2 of the learning management system server 23, so as to directly read the part of reference information content and related archive data stored in the teaching aid database 23D2 and open for access according to their respective user permissions. Or, by clicking the URL links to the extended test mobile application 5Da4, students can access the learning management website server 22 through the built-in web browser on their respective mobile devices 4, and further access the internal test paper database 23D3 of the learning management system server 23, so as to directly read the part of test paper content and related archive data stored in the test paper database 23D3 and open for access according to their respective user permissions.

While the invention has been described in terms of preferred embodiments, those skilled in the art will recognize that the invention can be practiced with modifications within the spirit and scope of the appended claims.

What is claimed is:

1. An interactive learning management method configured to implement in an interactive learning management system including a learning management mobile server, a learning management website server, a learning management system server, a system backup server, a plurality of mobile devices, and a mobile application platform server wherein the system backup server is configured with a data storage device; the learning management mobile server, the learning management website server, the learning management system server, and the system backup server are inter-connected via networking; wherein the learning management mobile server and the learning management website server can both access the Internet through networking; and the mobile application platform server can access the Internet through networking; the mobile devices can access the Internet through telecommunication network or wireless network, so as to access the learning management mobile server, the learning management website server or the mobile application platform server; the mobile application platform server is configured with a mobile applications database; and the mobile applications database includes: learning communication mobile application, tutoring course mobile application, teaching aid mobile application, extended test mobile application and game learning mobile application; wherein the learning communication mobile application is used between the student or parents for real-time and dynamic information notification, text newsletters transmission, archive photos provision, webpage links and learning information announcement; the tutoring course mobile application is for display of the documents and materials of the main content of the teaching course, dynamic multimedia audio and video interaction and URL links; the teaching aid mobile application is for display of the documents and materials of reference information of the teaching courses; the extended test mobile application is for provision of the test papers of the teaching courses progress tests, dynamic multimedia audio and video interaction and URL links; the game learning mobile application is for provision of interactive and dynamic multimedia audio and video games related to the content of the teaching courses; the learning management mobile server is configured with a mobile learning database, a real-time information mobile database, a video mobile database and a new knowledge mobile database; wherein the mobile learning database is for storage of the account numbers, personal information and student data of the students or parents who use the learning communication mobile application on the mobile devices; the real-time information mobile database is for storage of related data of text newsletters or archive photos transmitted between the students or parents and the learning management personnel via the learning communication mobile application; the video mobile database is for storage of video files for contacting or communication between the students or parents and the learning management personnel via video clips; the new knowledge mobile database is for storage of related data of abstracts and full-text links about recent culture, education, learning, enrollment, research and new knowledge; the learning management system server is configured with a teaching courses database, a teaching aid database, a test paper database and a new knowledge database; wherein the teaching courses database is for storage of all learning content and related archive data used for the teaching courses; the teaching aid database is for storage of all reference information and related archive data used for the teaching courses; the test paper database is for storage of all test paper content and related archive data; the new knowledge database is for storage of full texts and related data about domestic and overseas culture, education, learning, enrollment, research and new knowledge; the mobile devices is installed with a learning communication mobile application; the mobile devices can be networked through the installed learning communication mobile application, and access the learning management mobile server via the Internet; and the mobile devices can be networked through the built-in web browser, and access the learning management website server via the Internet; wherein the mobile devices can be smart phones or tablets; the system backup server can, via networking, regularly or irregularly back up the data files of the mobile learning database, the real-time information mobile database, the video mobile database and the new knowledge mobile database of the learning management mobile server in the data storage device of the system backup server; or, via networking, and back up the data files of the teaching courses database, the teaching aid database, the test paper database and the new knowledge database of the learning management system server in the data storage device of the system backup server, the interactive learning management method comprising the steps of:
installing the mobile devices with the learning communication mobile application which can access the learning management mobile server via the mobile devices, the learning communication mobile application can be automatically connected to the mobile learning database of the learning management mobile server, and by reading and comparing the account numbers, personal information and student data of the students or parents stored in the mobile learning database, automatically establish group settings or join class groups, parents groups, or learning groups in the learning communication mobile application based on the user identities on the mobile devices, so that the users or the learning management personnel can send or receive messages, data or files directly in the specific groups;
allowing a learning management personnel to access the learning management mobile server via the learning management system server, and based on the student account numbers stored in the mobile learning database of the learning management mobile server, directly send real-time information of text newsletters or archive photos of class announcements, tutor instructions, test paper scores, learning guides and advices to the mobile devices; and the learning management mobile server will automatically back up the sent real-time information of text newsletters or archive photos in the corresponding real-time information mobile database of the learning management mobile server for storage or reading; and the students can, by executing the learning communication mobile application installed on the corresponding the mobile devices, review the real-time information of text newsletters or archive photos sent by the learning management personnel;
allowing the learning management personnel to access the learning management mobile server via the learning management system server, and based on the parent account numbers stored in the mobile learning database of the learning management mobile server, directly send real-time information of text newsletters or archive photos about student check-in time, student check-out time, parent communications, test paper scores, tutor comments and replies to the corresponding mobile devices; and the learning management mobile server will automatically back up the sent real-time information of text newsletters or archive photos in the corresponding real-time information mobile database of the learning management mobile server for storage or reading; and the parents can, by executing the learning communication mobile application installed on the mobile devices, review the real-time information of text newsletters or archive photos sent by the learning management personnel;
allowing students or parents to access the learning management mobile server via the corresponding mobile devices, and reply or send real-time information of text newsletters or archive photos via the learning communication mobile application installed on the mobile devices; and the learning management mobile server will automatically back up the received real-time information of text newsletters or archive photos in the corresponding real-time information mobile database of the learning management mobile server for storage or reading; and the learning management personnel can access the learning management mobile server via the learning management system server, and review the real-time information of text newsletters or archive photos sent by the students or parents in the real-time information mobile database of the learning management mobile server;
allowing the learning management personnel to access the learning management mobile server via the learning management system server, and based on the student account number or parent account number stored in the mobile learning database of the learning management mobile server, directly send related data of abstracts and full-text links about recent culture, education, learning, enrollment, research and new knowledge stored in the new knowledge mobile database of the learning management mobile server to the corresponding mobile devices;
allowing the students or parents to, by executing the learning communication mobile application installed on the mobile devices, review the related data of abstracts and full-text links about recent culture, education, learning, enrollment, research and new knowledge sent by the learning management personnel; or, by clicking the full-text links, access the learning management website server through the built-in web browser of the mobile devices and further access the new knowledge database of the internal learning management system server, so as to directly read the full texts and related data about domestic and overseas culture, education, learning, enrollment, research and new knowledge stored in the new knowledge database;
allowing the students to make video clips of questions for any unclear or doubtful parts in the classroom teaching content, teaching aid materials or test papers, and describe the questions that are not clear or can not be understood through the video clips;
allowing the students to access the learning management mobile server via their respective mobile devices, and send question video clips via the learning communication mobile application installed on the mobile devices, the learning management mobile server will automatically back up the received questions video clips in the corresponding video mobile database of the learning management mobile server for storage or reading;
allowing the learning management personnel to access the learning management mobile server via the learning management system server, and review the question video clips sent by the students in the video mobile database of the learning management mobile server, and notify the teacher to make reply video clips according to the question video clips of the students, to explain and clarify the related questions of the students;
when the learning management personnel has obtained the reply video clips provided by the teacher, allowing the learning management personnel to access the learning management mobile server via the learning management system server, and back up the reply video clips in the video mobile database of the learning management mobile server for storage and reading; and meanwhile, based on the student account numbers stored in the mobile learning database of the learning management mobile server, the learning management personnel can directly send real-time information of text newsletters of reply notifications and reply video clip file links to the corresponding mobile devices;
allowing the students to, by executing the learning communication mobile application installed on their respective mobile devices, review the real-time information of text newsletters of the reply notifications sent by the learning management personnel and the file links to the stored reply video clips, and know that the teacher has replied to their question video clips; and by clicking the file links to the stored reply video clips, access the learning management mobile server via their respective mobile devices, to play the reply video clips stored in the video mobile database of the learning management mobile server on the mobile devices;
allowing the students to access the mobile application platform server via their respective mobile devices, and review the tutoring course mobile application, the teaching aid mobile application, the extended test mobile application and the game learning mobile application in the mobile applications database of the mobile application platform server based on their respective learning needs; and download and installed the mobile applications needed on their respective mobile devices, and review the key points of the teaching courses by executing the tutoring course mobile application on the mobile devices, or carry out aided learning with reference information of the teaching courses by executing the teaching aid mobile application, or carry out self-tests with the progress tests of the teaching courses by executing the extended test mobile application, or carry out fun learning of related content of the teaching courses by executing the game learning mobile application; and
by clicking the URL links to the tutoring course mobile application, allowing the students to access the learning management website server through the built-in web browser on their respective mobile devices, and further access the internal teaching courses database of the learning management system server, so as to directly read the part of course learning content and related archive data stored in the teaching courses database and open for access according to their respective user permissions; or, by clicking the URL links to the teaching aid mobile application, students can access the learning management website server through the built-in web browser on their respective mobile devices, and further access the internal teaching aid database of the learning management system server, so as to directly read the part of reference information content and related archive data stored in the teaching aid database and open for access according to their respective user permissions; or, by clicking the URL links to the extended test mobile application, students can access the learning management website server through the built-in web browser on their respective mobile devices, and further access the internal test paper database of the learning management system server, so as to directly read the part of test paper content and related archive data stored in the test paper database and open for access according to their respective user permissions.
